(19) United States
(12) Patent Application Publication
(10) Pub. No.: US 2023/0394191 A1
(43) Pub. Date: Dec. 7, 2023

(54) METHODS AND SYSTEMS OF GEOMETRIC REPRESENTATION GENERATION BASED ON A SYSTEM-LEVEL MODEL

(71) Applicant: Palo Alto Research Center Incorporated, Palo Alto, CA (US)

(72) Inventors: Randi Wang, Mountain View, CA (US); Anurag Bhattacharyya, Mountain View, CA (US); Qian Ye, Sunnyvale, CA (US); Clinton Morris, San Carlos, CA (US); Amirmassoud Mirzendehdel, Millibrae, CA (US); Morad Behandish, San Mateo, CA (US)

(21) Appl. No.: 17/831,125

(22) Filed: Jun. 2, 2022

(51) Int. Cl. G06F 30/18

(52) U.S. Cl. CPC G06F 30/18; G06F 2111/04

(57) ABSTRACT

This disclosure provides techniques for automatically generating a geometric representation based on a system-level model (e.g., a lumped parameter model, or LPM). The geometric representation may include a three-dimensional (3D) or cross-sectional shape, resulting from topology optimization within a design space automatically generated without human intervention. An example method may include identifying one or more constraints for each of two or more components of an LPM. One or more conditions are generated for the LPM. The one or more conditions are mapped to the one or more constraints. A processing device may generate a design space for a geometric representation to perform functions represented by the LPM. The geometric representation is subject to the generated one or more conditions. The processing device may then perform topology optimization of the geometric representation in the design space to generate an optimized geometry (e.g., a converged and/or final output).

### TECHNICAL FIELD

Implementations of the present disclosure relate to generating shapes by topology optimization for manufacturing.

### BACKGROUND

Topology optimization optimizes material layout or where materials are formed in a functional structure within a given design space, for a given set of loads, boundary conditions and constraints. For example, when a beam is given a certain load (or a distribution of loads), the beam may take on certain shapes having varying material layouts at different cross-sections for minimizing the overall deformation, depending on the material properties, allowable weight ranges and other constraints. Instead of starting with certain uniform cross-sectional designs and evaluating respective performances, topology optimization automatically computes an ideal shape for the given loading and boundary conditions.

Topology optimization often applies to components on a geometric level (e.g., based on a given one geometry and changed into another geometry that satisfies given conditions). However, engineering designs often start with desired functions or behaviors on a system level (instead of geometric level). On the system level, the engineering process may first define what a member does, before defining what the member looks like on the geometric level. To provide a geometric shape for achieving given functions, existing practice relies on costly manual assignments or iterations based on the desired functions or behaviors, accompanied by errors and inefficiency.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates a block diagram of an automatic shape generation system based on system-level models, in accordance with certain aspects of the present disclosure.

FIG. 2 illustrates a block diagram of data flow in generating a geometric representation based on a system-level model, in accordance with certain aspects of the present disclosure.

FIGS. 3A and 3B illustrate an example of generating a system-level geometric representation that is functionally replaceable with an assembly, in accordance with certain aspects of the present disclosure.

FIG. 4 illustrates an example of providing a distributed-parameter model (DPM) to match lumped-parameter model (LPM), in accordance with certain aspects of the present disclosure.

FIG. 5 illustrates an example of matching LPM with an DPM, in accordance with certain aspects of the present disclosure.

FIG. 6 illustrates an example of formulating a three degree-of-freedom (d.o.f.) system-level model in a static mechanical domain to be solved with a geometric representation by topology optimization, in accordance with certain aspects of the present disclosure.

FIG. 7 illustrates an example of generating a design domain for generating the geometric representation of FIG. 6, in accordance with certain aspects of the present disclosure.

FIG. 8 illustrates an example of generated design domains from initial positions of lumped components for generating a geometric representation of a one d.o.f system-level model, in accordance with certain aspects of the present disclosure.

FIG. 9 illustrates an example of generating boundary conditions from lumped sources for generating the geometric representation of FIG. 8, in accordance with certain aspects of the present disclosure.

FIG. 10 illustrates a flow diagram of methods of operations, in accordance with certain aspects of the present disclosure.

FIG. 11 illustrates a flow diagram of automatic generation of geometric representation based on system-level models, according to a topology optimization method of the present disclosure.

FIG. 12 illustrates an example of a one degree-of-freedom mass-spring-damper system-level model and a generated design space, for demonstrating aspects of the present disclosure.

FIGS. 13A-13F illustrate example topology optimization results of shapes generated for the mass-spring-damper model of FIG. 12, for demonstrating aspects of the present disclosure.

FIG. 14 illustrates an example of a multi d.o.f. mass-spring-damper system-level model and a design space generated for topology optimization, for demonstrating aspects of the present disclosure.

FIGS. 15A-15X illustrate example topology optimization results of shapes generated for the mass-spring-damper model of FIG. 14, for demonstrating aspects of the present disclosure.

FIG. 16 illustrates an example of a multi d.o.f. mass-spring-damper system-level model and a design space generated for topology optimization, for demonstrating aspects of the present disclosure.

FIGS. 17A-17P illustrate example topology optimization results of shapes generated for the mass-spring-damper model of FIG. 16, for demonstrating aspects of the present disclosure.

FIG. 18 illustrates an example computational device for performing operations of topology optimization to generate a geometric representation based on a system-level model, in accordance with certain aspects of the present disclosure.

Like numerals indicate like elements.

### DETAILED DESCRIPTION

The present disclosure provides various techniques for generating a geometric representation based on a system-level model (e.g., a lumped parameter model, or LPM). The geometric representation may include a three-dimensional (3D) or cross-sectional shape, resulting from topology optimization within a design space automatically generated without human intervention. That is, given a system-level model that defines desired functions and limiting conditions (e.g., boundary and initial conditions), the disclosed techniques may automatically output an optimized geometric representation that performs the desired functions.

According to aspects of the present disclosure, an example method may include identifying one or more constraints for each of two or more components of an LPM. One or more conditions are generated for the LPM. The one or more conditions are mapped to the one or more constraints. A processing device may generate a design space for a geometric representation to perform functions represented by the LPM. The geometric representation is subject to the generated one or more conditions. The processing device may then perform topology optimization of the geometric representation in the design space to generate an optimized geometry (e.g., a converged and/or final output).

Conventional topology optimization often starts with given geometry subject to known boundary conditions (BCs) and initial conditions (ICs). The given geometry may be a part or an assembly. The given geometry may be inherently separate from its intended function, for example, a long screw may be used to function as a cantilever beam, or a nut may be used to function as a spacer. Therefore, the starting geometry may substantially deviate from an optimized shape specific to intended functions. The present disclosure overcomes such inefficiencies by automatically generating a design space based on a system-level model, such as an LPM, and automatically generating geometric representation based on the corresponding functions of the LPM, thus avoiding errors or inefficiencies introduced by the initial arbitrary starting geometry.

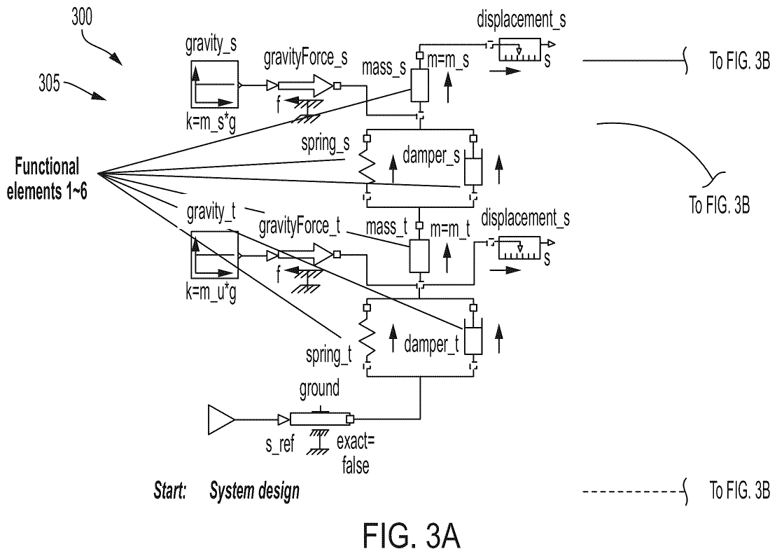

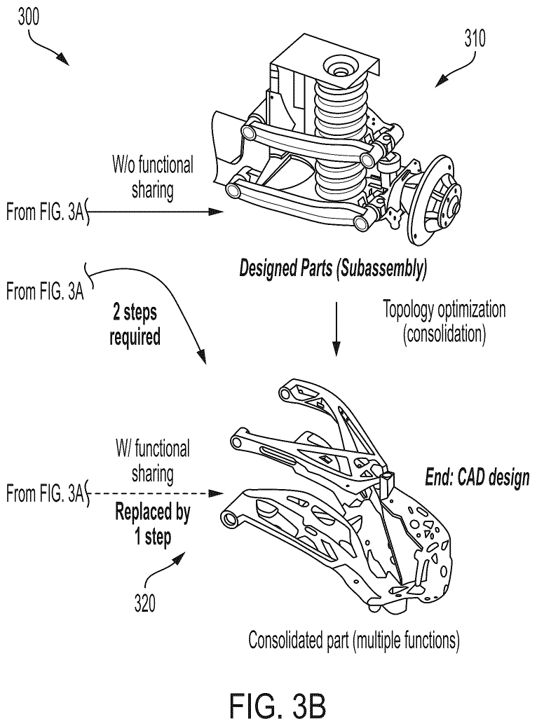

Aspects of the present disclosure thus follow the system-level design, which usually comes first at the conceptual and functional levels. The automatically generated geometric representation matches the functional specifications of the system-level design while satisfying manufacturing constraints. The methods and techniques disclosed herein allows for automatic shape realization (e.g., geometric representation generation) from system-level structural and behavioral information. In some cases, because the automatic shape realization is based on matching functions of a system-level model, which may be achieved by one part or a multiple-part-assembly, the disclosed techniques allow for topology optimization on an assembly of multiple parts as well as on a single part (as shown in FIG. 3).

According to aspects of the present disclosure, methods and systems are provided to automatically realize shapes and/or geometries based on LPMs based on topology optimization, constrained by system-level behavior mapped to part-level specifications (e.g., functions and conditions on parts in an assembly). As such, the techniques herein provide a function-to-shape design method for generating different geometric realizations could be found for the same network of functional elements, satisfying different manufacturing and assembly requirements. The disclosed techniques provide a systematic manner to generate geometric parts to perform multiple functions and to enable function-to-shape automation at a large-scale assembly level.

As further discussed below, a shape realization framework for lumped-parameter mechanical systems is presented. In this framework, families of geometric realizations may be generated for a common network of lumped components—thus avoiding premature suboptimal decisions and enabling more freedom to satisfy downstream manufacturing and assembly requirements. In addition, the framework based on topology optimization may optimize the consistency between part-level and system-level specifications and behaviors (e.g., functions). Furthermore, the framework enables the realization of multiple lumped system components with a single part or shape. For example, the present disclosure used a “multi-density” topology optimization, in which multiple lumped-parameter system components are realized by a superposition of densities that define a single part. That is, rather than decomposing the 3D space in any arbitrary fashion to associate the subdomains to each lumped mass, the present disclosure let the topology optimization decide on how the mass should be distributed to achieve consistency in terms of matching moments of distributed quantities with their lumped counterparts, e.g., matching center of mass for each density layer against the location of corresponding lumped mass.

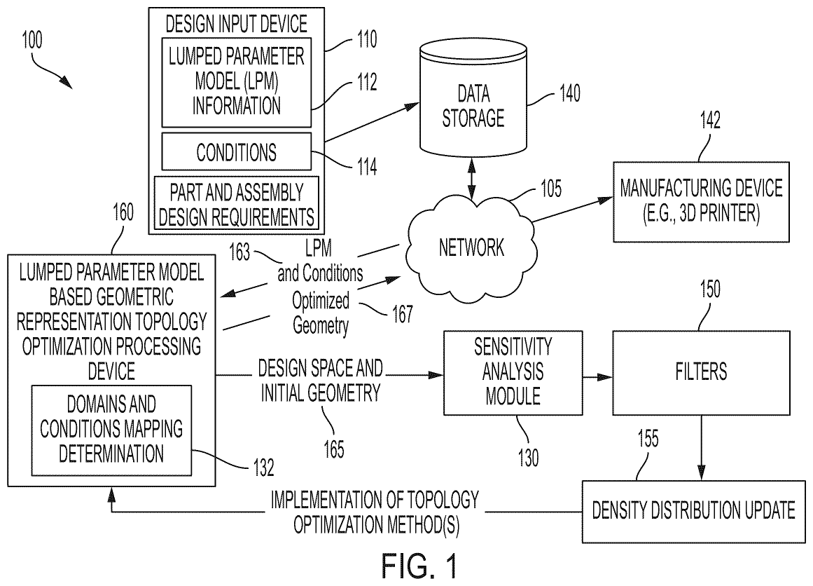

FIG. 1 illustrates a block diagram of an automatic shape generation system (or apparatus) 100 based on system-level models, in accordance with certain aspects of the present disclosure. As shown, the shape generation system 100 includes a lumped parameter model (LPM) based geometric representation topology optimization (TO) processing device, which may receive system-level model and production information from the data storage 140 via the network 105.

The LPM model based geometric representation TO processing device 160 may automatically generate shapes, forms, or geometric representations to functionally match a system-level model, as described by an LPM. In some cases, the shapes may substitute an assembly of two or more components based on the LPM and conditions information 163 and return an optimized geometry 167 to the data storage 140, as well as sending, via the network 105, the optimized geometry 167 to be manufactured, such as in the manufacturing device 142 (e.g., a 3D printer). The LPM and conditions information 163 is based on (e.g., includes or is converted from) the LPM information 112, the conditions 114, and part and assembly design requirements 116, received in the design input device 110, held by the data storage 140, and transmitted via the network 105.

In some cases, shape and production information may be received at the design input device 110, which may include any computational terminal, such as a standalone computational device that includes individual processing and storage capacities. The design input device 110 may receive various inputs from a user, such as model designs or shape information of each component, the LPM information 112, various initial and boundary conditions 114, and part and/or assembly design requirements 116. The conditions 114 may include respective conditions applicable to each part of an assembly as well as conditions applicable to the assembly as a whole (e.g., temperature, field forces, translational velocity, etc.).

The LPM information 112 may include an LPM having one or more functional descriptions (e.g., in relation to mass, loads, movements, energy, etc.). The conditions 114 may include various initial conditions (ICs) and/or boundary conditions (BCs), and other conditions that require a solution of the system-level topology optimization to satisfy. The part and assembly design requirements 116 may include assembly information (e.g., mating surfaces, edges, vertices, etc.), relative positions, coordinate information, and other positional constraints of the components.

In one example, boundary conditions include a set of constraints for a boundary value model or modeling represented by a differential equation. A solution to the boundary value model or modeling represented by the differential equation is a solution that satisfies the boundary conditions. For example, boundary conditions may include physics, space, and geometry limitations of the assembly of two or more components. In a dynamic system, initial conditions may include various seed values of variables for computation and optimization. The initial conditions set out a starting state for changes to occur over time. For example, computations of deformation, movement, and other aspects of the assembly of two or more components may vary over time, based on a set of initial conditions provided.

In some cases, the conditions 114 may also include parameters related to material properties associated with manufacturing techniques. For example, elasticity or strength of the geometric representation of the assembly may cause different optimization results under common loading and boundary conditions. The conditions 114 may therefore include any parameters, variables, or considerations that may impact the system-level topology optimization.

In some cases, the data storage 140 may store the optimized geometry 167. The network 105 may, upon demand or request by a user, provide the shape and/or production information associated with the optimized geometry 167 to the manufacturing device 142.

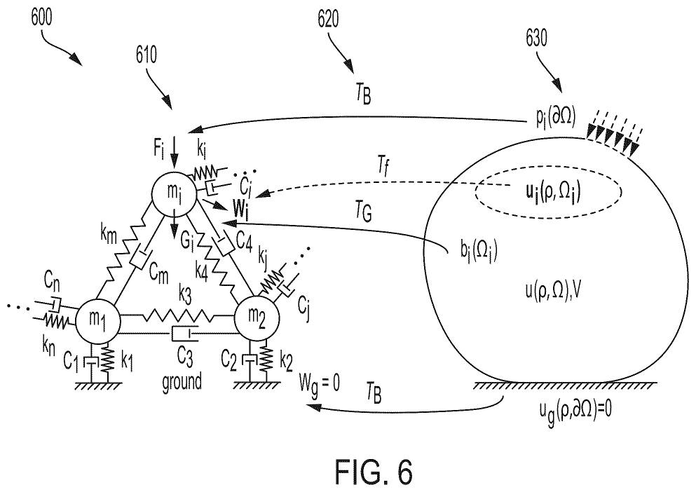

The LPM model based geometric representation TO processing device 160 may obtain information from the data storage 140 and generate the optimized geometry 167 based on the LPM and conditions information 163. For example, in general, the processing device 160 may identify one or more constraints for each of two or more components of an LPM. For example, the two or more components of the LPM may functionally represent performances to be achieved by an assembly of two or more parts. For example, a suspension (e.g., an assembly) may include a spring and a damper (e.g., two parts) to perform elastic deformation and vibration reduction (e.g., functions described in a system-level model). The processing device 160 may generate one or more conditions for the LPM, such as by using the module 132 of domains and conditions mapping determination. For example, in the above example, the condition may include a common displacement in the spring and in the damper (see FIGS. 6-9).

The processing device 160 may then generate a design space 165 for the geometric representation (e.g., starting from an initial geometry, updated by iterations until convergence) to perform functions represented by the LPM. The geometric representation is subject to the generated one or more conditions. The processing device 160 performs topology optimization of the geometric representation in the design space 165 to generate the optimized geometry 167. The processing device 160 may generate the design space 165 for the geometric representation of the LPM by receiving a network of connected lumped components for the LPM and by identifying one or more corresponding lumped sources acting on the network of connected lumped components of the LPM. In some cases, generating the design space for the geometric representation of the LMP includes determining a geometric design domain that bounds a shape and a size of the geometric representation, based on an initial position of each of the two or more components of the LPM. The one or more corresponding lumped sources may include the initial position of each of the two or more components.

In some cases, the processing device 160 may perform topology optimization based on system-level models instead of part or assembly geometries. As such, the processing device 160 may skip starting from initial geometries of parts and/or assembly, as shown in FIGS. 3A and 3B. Turning briefly to FIGS. 3A and 3B, an example 300 of generating a system-level geometric representation 320 that is functionally replaceable with an assembly 310 is shown, in accordance with certain aspects of the present disclosure.

Turning first to FIG. 3A, a system-level model 305 of an automotive suspension system is shown. The system-level model 305 includes, for example, six functional elements performed by different suspension components. For example, the functional elements describe elastic deformation, damping or vibration characteristics, and accelerations caused by various forces. A perspective view of the suspension system is shown on top of FIG. 3B.

In view of both FIGS. 3A and 3B, conventional workflow starts with the assembly 310 of multiple components: spring, shock-absorber, arms, hinges, bearings, etc. Human intervention defines geometric representations to obtain the design parts of the assembly 310 as shown. After obtaining the designs (e.g., geometric shapes, material properties, etc.) of the assembly 310, one or more parts of the assembly 310 may then be optimized for reducing weight, improving reliability, or other optimization functions. As such, the conventional workflow includes two distinct steps: human designing of parts and topology optimization of the parts. As such, the system level consideration is separated from topology optimization, subject to errors and inefficiencies.

By comparison, aspects of the present disclosure provide techniques for performing topology optimization to generate a geometric representation directly based on a system-level model, such as an LPM. Instead of performing two separate steps as mentioned above, the present disclosure may start from the system-level model 305, given a design domain to perform the required functions, to generate a shape or geometry in one step (may include one or more iterations) to perform the functions of the assembly 310. This way, the optimized geometric representation may functionally replace the assembly 310

In the example shown in FIG. 3B, the optimized geometric representation 320 may be produced in one piece. Comparing to the assembly 310 of multiple parts, this simplifies post-manufacturing assembly or fitting and increasing reliability by avoiding failures of individual parts. For example, the single-piece optimized (e.g., by mass, by cost, or by certain aspects of performance) geometric representation 320 may elastically deform and dampen vibrations, while providing support to the vehicle as intended and capable of replacing the assembly 310.

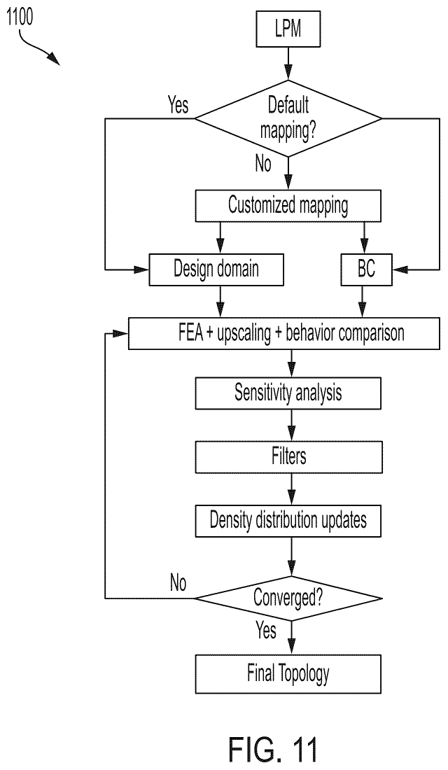

Returning to FIG. 1, the LPM model based geometric representation TO processing device 160 may form an iterative computation loop with other processing modules, including the sensitivity analysis module 130, one or more filters 150, and a density distribution update module 155. The LPM model based geometric representation TO processing device 160 may further include a computational module 132 for computing: design domains and conditions mapping from system level to geometric level, and provide an initial geometric-level representation in the design space 165 to the sensitivity analysis module 130 (example in FIG. 11).

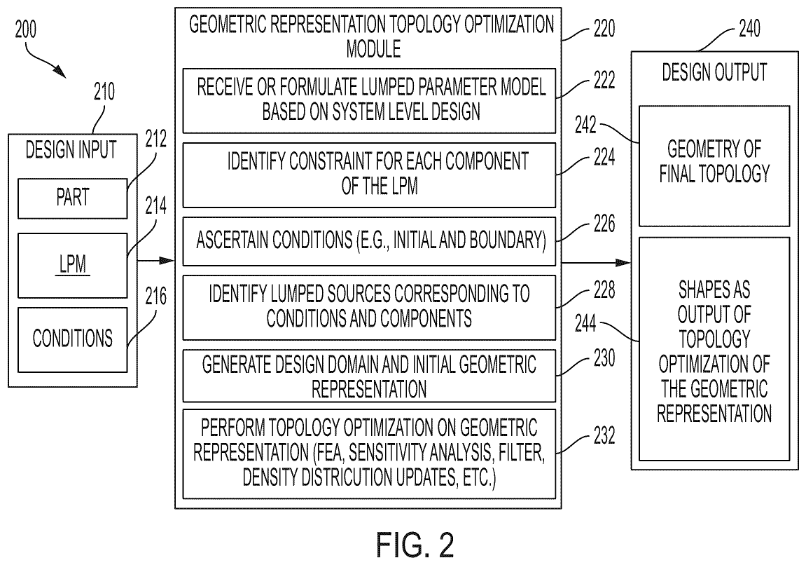

Details operations of the LPM model based geometric representation TO processing device 160, the module 132 for domains and conditions mapping determination, the sensitivity analysis module 130, the filters 150, and the density distribution update module 155 are further discussed in view of FIGS. 2, 10, and 11.

Although the design input device 110 and the LPM model based geometric representation TO processing device 160 are illustrated as two separate devices, in some cases, the design input device 110 and the LPM model based geometric representation TO processing device 160 may be included in a same computational system (or two modules on a common computational platform). In some cases, the design input device 110 may have sufficient computational power to behave as the LPM model based geometric representation TO processing device 160, or the LPM model based geometric representation TO processing device 160 may include one or more user interfaces to receive direct input of modeling and production parameters therein.

In some cases, the design input device 110 may be a consumer terminal (e.g., a personal computer, a smart phone, etc.) that enables a user to upload system-level models, conditions, and other relevant information to the data storage 140. The LPM model based geometric representation TO processing device 160 may behave as a server performing requested services to modify or improve the shape and production information in the data storage 140, via the network 105. The data storage 140 may store production information separate from the design input device 110 (e.g., from the manufacturing device 142). The systems, techniques, and methods disclosed herein may therefore be applicable without a fixed terminal for the design input device 110, and rather, a flexible web-based service that connects user data, processing devices, and manufacturing devices in one production optimization environment.

FIG. 2 illustrates a block diagram 200 of data flow in generating a geometric representation based on a system-level model, in accordance with certain aspects of the present disclosure. As shown, design input 210 is provided to a geometric representation topology optimization module 220, which generates the design output 240. The design input 210 may include at least part and/or assembly information 212, a system-level model or an LPM 214 (or any general system level model 214) that matches functions or behaviors of the part/assembly information 212, and conditions 216 applicable to the system-level model 214 during operations. The conditions 216 may include various boundary and initial conditionals for the part/assembly information 212 and the system-level model 214. In some cases, the design input 210 may use LPM models under presumptions of materials or manufacturing conditions.

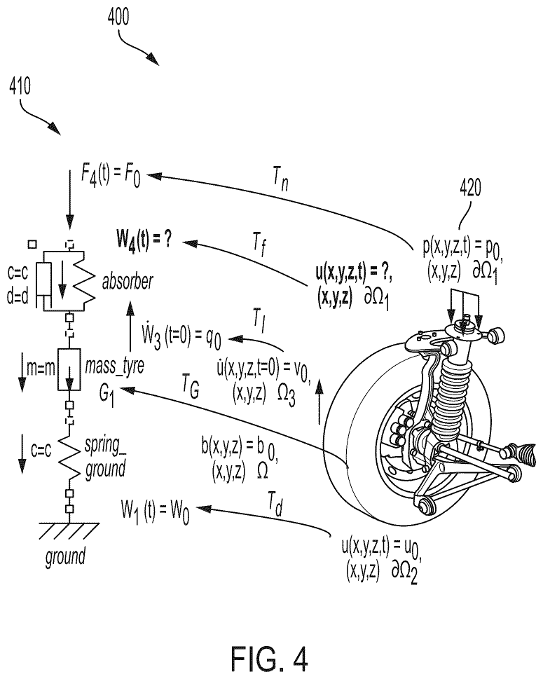

Upon receiving the design input 210, the geometric representation topology optimization module 220 may, at 222, receive the system-level model 214 or formulate an LPM based on the information available in the design input 210. For example, for generating the geometric representation of the system-level model 214, the geometric representation topology optimization module 220 may identify one or more corresponding lumped sources acting on the network of connected lumped components of the LPM (e.g., at 228, see also examples in FIGS. 4-6).

At 224, the geometric representation topology optimization module 220 identifies constraints for each component of the LPM. For example, the LPM may include functional constraints based on the system-level design, such as desirable functions or feasible functions in the design domain.

At 226, the geometric representation topology optimization module 220 ascertains various conditions (e.g., from the conditions 216) applicable to the part/assembly information 212 and the system-level model 214. For example, the one or more corresponding lumped sources may correspond to at least a portion of the one or more constraints of the two or more components. The one or more constraints include initial conditions and boundary conditions of the two or more components. The initial conditions and the boundary conditions may specify functional requirements for the two or more components.

At 228, the geometric representation topology optimization module 220 identifies lumped sources corresponding to conditions and components. The lumped sources may correspond to the conditions and components ascertained above. In some cases, the geometric representation topology optimization module 220 may obtain material properties and manufacturing parameters associated with an additive manufacturing process of the geometric representation. The geometric representation topology optimization module 220 may generate an optimized material layout to satisfy: the one or more corresponding lumped sources, the material properties of the geometric representation, and the manufacturing parameters associated with the additive manufacturing process.

At 230, the geometric representation topology optimization module 220 generates design domain and initial geometric representation. For example, the geometric representation topology optimization module 220 may determine a geometric design domain in which a shape and a size of the geometric representation are bounded. Examples are further discussed in FIGS. 6-9, 12, and 14-17. The geometric representation topology optimization module 220 may determine the geometric design domain in view of an initial potion of each of the two or more components. The one or more corresponding lumped sources may include the initial position of each of the two or more components.

At 232, the geometric representation topology optimization module 220 performs topology optimization on the geometric representation, such as by finite element analysis (FEA), sensitivity analysis, filter, destiny density distribution updates, among others. In some cases, the geometric representation topology optimization module 220 performs the topology optimization of the system level representation using one or more of various optimization methods, including an element-based topology optimization method, a rational approximation of material properties method, a level set optimization method, an optimal microstructure with penalization method, an evolutionary structural optimization method, an additive evolutionary structural optimization method, and/or a bidirectional evolutionary structural optimization method.

In some cases, the geometric representation topology optimization module 220 may obtain material properties and manufacturing parameters associated with an additive manufacturing process of the geometric representation. The geometric representation topology optimization module 220 may generate an optimized material layout to satisfy: the one or more corresponding lumped sources, the material properties of the geometric representation; and the manufacturing parameters associated with the additive manufacturing process.

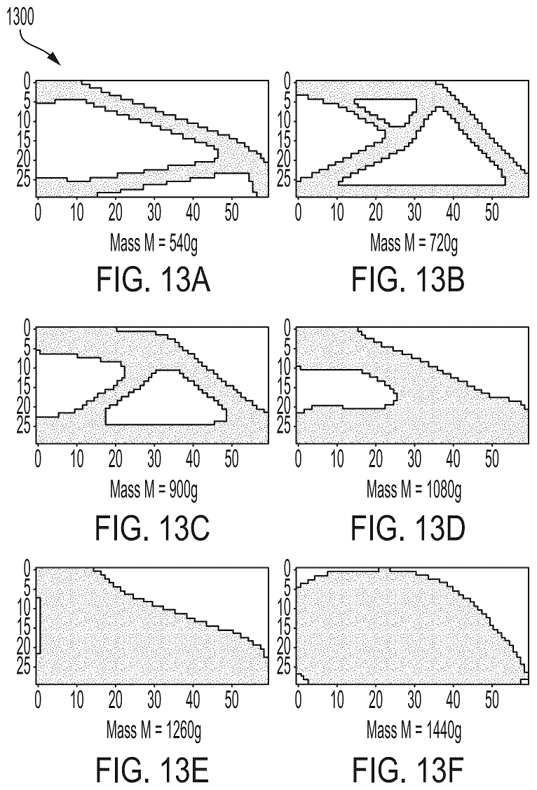

The design output 240 may include the geometric representation of the final topology 242 and/or one or more shapes as output of topology optimization of the geometric representation 244 (e.g., shapes before convergence or finalization). According to aspects of the present disclosure, shapes, geometries, and geometric representations may be interchangeable. The geometry may be defined by a density model (each coordinate having a value between 0 and 1), a point cloud model (vertices each having a coordinate), a parametric model (a shape defined by one or more parameters), or a combination thereof. The geometric representation 242 or 244 as output, is capable of performing functions of the system-level model 214 or any part/assembly associated with the LPM. The shape may be specific to one or more materials to be used and specific to manufacturing techniques that are specific to the one or more materials to be used. Examples of geometric representations are shown in FIGS. 13A-13F, 15A-15X, and 17A-17P.

As illustrated in the examples below, the present disclosure formulates a well-posed shape generation model or modeling for lumped-parameter systems in the mechanical domain. The present disclosure also provides an approach for automatic generation of 3D parts that are consistent in terms of behavior with a network of connected lumped mechanical components. The consistency means that under the specified correspondence between system- and part-specifications, the error between the system and part-level behavior is sufficiently small.

Aspects of the present disclosure provide a shape generation framework for lumped-parameter systems, where function sharing is considered such that sub-systems consisting of multiple components could be realized by a single geometric part. The present disclosure adopts density-based topology optimization, using a solid isotropic material with penalization (SIMP) scheme, for 3D design space exploration. Classical topology optimization approaches commonly optimize as objective function a physics-based performance metric (e.g., stiffness or strength) evaluated by a forward solver such as finite element analysis (FEA). The objective function may or may not be penalized by violation of additional constraints such as manufacturability. In contrast, the present disclosure uses measures of consistency between part-level and system-level behavior as the objective function.

According to aspects of the present disclosure, system-level specifications (e.g., lumped parameters and source terms) are used to systematically specify the solving a model using topology optimization specifications (e.g., 3D design domain, boundary conditions, and body effects). The objective function for topology optimization, on the other hand, is defined as a global error between the part-level behavior (e.g., integral properties of displacement field) computed by FEA and the system-level behavior (e.g., steady-state displacement) computed using reduced-order solvers.

To illustrate aspects of the present disclosure, topology optimization for flexible mechanical parts is performed to match the behavior of mass-spring-damper models upon lumping. For each mass-spring-damper model, a family of geometric designs that are consistent with the lumped-parameter behavior are realized. Note that the present disclosure is not limited to a specific domain of physics or engineering application, e.g. mechanical domain. The techniques herein may be used to generate geometric design for system design of many different physical domains such as electrical, thermal, and hydraulic domains, etc. and their combinations.

According to aspects of the present disclosure, a lumped parameter model is built as an input, using languages such as Modelica™, Simulink™, linear graphs, and bond graphs, etc. The model includes a network of connected lumped components (such as mechanical springs, dampers, and masses, electrical capacitors, inductors, and resistors, etc.) and lumped sources (such as mechanical forces and displacements, electrical current and voltage sources, etc.).

Then, a processing device of the present disclosure, based on the input, is provided with the geometric part design domain whose shape and size are determined according to the initial position of lumped components. The lumped sources are systematically mapped to the boundary condition of the design domain, where the mapping has a default form but supports customization by users considering different practical applications scenarios.

The processing device of the present disclosure applies a topology optimization technique that gives an optimized material layout within the design domain, for the given boundary conditions and other customized assembling (e.g. holes of fixed positions) and manufacturing constraints (e.g. volume fractions).

The processing device generates an output, which is an optimal geometric part whose error is minimized compared to other designed forms with different material layouts in the design domain. Particularly, the error could be tuned by selecting different material properties to satisfy a user-specified tolerance for errors, if necessary.

In some cases, examples of topology optimization methods that can be applied may be element-based methods, such as a Solid Isotropic Material with Penalization (SIMP) method, a level set method, a Rational Approximation of Material Properties (RAMP) method, an Optimal Microstructure with Penalization (OMP) method, and a phase field method, and the like. The topology optimization methods may also include discrete methods such as an Evolutionary Structural Optimization (ESO) method, an Additive Evolutionary Structural Optimization (AESO) method, and a Bidirectional Evolutionary Structural Optimization (BESO) method. The topology optimization methods may also include a combination of any of these methods.

The present disclosure provides a non-intrusive integration with existing software for topology optimization (e.g. ANSYS™, Abaqus/ATOM™, Genesis™, NX Topology Optimization™, Optistruct™, and TOSCA™).

The present disclosure may seamlessly, systematically, and automatically generate a 3D generation for a system network by using the mature topology optimization technique. The tool offers a one-directional interface for integrating the system and 3D modeling tools. Particularly, the option to add different assembling and manufacturing constraints to the design space gives modeling scientists or engineers sufficient freedoms of geometric designs. In principle, the semantics behind the tool could be adopted to interface different popular commercial system modeling tools (e.g. Dymola and Simulink), 3D modeling tools (e.g. SolidWorks and CATIA), and CAE analysis tools (e.g. COMSOL and ANSYS).

According to aspects of the present disclosure, a lumped-parameter model (LPM) is a system-level description. On the other hand, a distributed-parameter model (DPM) explicitly accounts for the shape and material distribution in 3D space, specifications, behaviors, initial/boundary condition (IC/BC), and body effect (BE) correspondences.

In some cases, a ‘DPM’ is a mathematical model of a well-posed initial/boundary value model or modeling, whose specifications are: 1) a set of symbolic partial differential equations (PDEs); 2) the region of space-time over which the PDEs govern the behavior; 3) ICs and/or BCs to be met at the borders of the space-time domain Ω×[0, ∞) [21]. The PDEs of DPM can be symbolically represented by:

[symbol]

(x,y,z,t,∂ₓ,u, . . . ,∂₁,u,∂ₓₓ²u,∂_{xy}²u, . . . ,∂_{x . . . t}ⁿu;μ)−0,

where u=u(x, y, z, t) is a dependent field variable which depends on the independent space variables (x, y, z)ϵΩ and time tϵ[0, ∞). The operator [symbol] may be any function of independent and dependent variables and derivatives of the dependent variable with respect to independent variables. μ is a set of (potentially time and/or space-dependent) parameters that generally have certain physical meanings such as mass density, solid elasticity, fluid viscosity, thermal conductivity, etc. The solution u of [symbol] =0 is generally required in some region of space and time, anchored by Dirichlet or Neumann BCs and initial conditions.

By comparison, an ‘LPM’ is a mathematical model of a well-posed initial-value model or modeling whose specifications are: 1) a system of symbolic ordinary differential equations (ODEs) or differential-algebraic equations (DAEs); 2) the period of time over which the ODEs/DAEs govern the behavior; and 3) ICs. The ODEs of the LPM can be symbolically represented by:

G(t,w,\dot{w},\ddot{w} . . . ;θ)=0,

where w=w(t) is a vector of a finite number of state variables (e.g., temporal signals) that depend on time tϵ[0, ∞). The operator G, boldfaced to emphasize the vector form of equations, may be any function of state variables and its time derivatives. θ is a set of (potentially time-dependent) parameters that generally have certain physical meanings such as lumped mass, spring stiffness, damper friction, voltage source, hydraulic capacitance, thermal resistance, etc. The solution w of G=0 is generally required over some time interval of interest starting from ICs. The present disclosure introduces definitions of the correspondence of the IC/BC and the functions of interest between a given LPM and a given DPM, modeling the same physical system.

In some cases, an ‘IC correspondence’ between an LPM and a DPM is a functional T_{I} that maps the ICs of DPM to the ICs of LPM:

T_{I}:u⁽ⁱ⁾(x,y,z,0)→w⁽ⁱ⁾(0),∀(x,y,z)ϵΩ

where i represents the order of time derivative.

FIG. 4 illustrates an example 400 of providing a distributed-parameter model (DPM) of an assembly 420 to match lumped-parameter model (LPM) 410, in accordance with certain aspects of the present disclosure. An example of T_{I} is shown in FIG. 4, where it maps the initial velocity of the tire's center of mass (for example) to the initial velocity of the lumped mass T_{I}:\dot{u}(x, y, z, 0)→\dot{w}₃ (0).

A ‘BC correspondence’ between an LPM and a DPM is a pair of functionals:
(i) A functional T_{d} that maps the Dirichlet BCs of DPM to an equality constraint on state variables of the LPM:

T_{d}:u(x,y,z,t)→w(t),∀(x,y,z)ϵΓ_{d},∀t≥0.
(ii) A functional Tₙ that maps the Neumann BCs of DPM to lumped source terms of the LPM:

$${T}_{n} : \frac{\partial u}{\partial u} ( x , y , z , t ) \to {θ}_{n} ( t ) , ∀ ( x , y , z ) ∈ {Γ}_{n} , ∀ t \geq 0.$$

Γ_{d}, Γₙ⊆∂Ω are predefined subsets of the boundary ∂Ω of the domain over which the Dirichlet and Neumann BCs are specified, respectively. θₙ(t) is the vector of source terms, included in θ(t).

FIG. 4 further shows an example in which the BC correspondence is given by T_{d}:u(x, y, z, t)→w₁(t), mapping the displacement of contact surface between the tire and ground in the DPM to the displacement of lumped spring connected to the ground in the LPM, and Tₙ:p(x, y, z, t)→ [symbol] ₄(t) maps the pressure on the top surface of absorber to the lumped force added to the lumped spring-damper component in the LPM. A ‘BE correspondence’ between an LPM and a DPM is a functional T_{G} that maps the body effect of the DPM to lumped source terms in the LPM:

T_{g}:μ_{g}(x,y,z,t)→θ_{g}(t),∀(x,y,z)ϵΩ,∀t≥0.

In FIG. 4, an example in which the BE correspondence is given by T_{g}:μ_{g}(x, y, z, t)→θ_{g}(t), mapping the body force of the whole car suspension due to gravity to a lumped source term added to the lumped mass.

According to aspects of the present disclosure, a ‘field correspondence’ between an LPM and a DPM is a functional T_{f} that maps the field variables of DPM, within the interior of the domain, to state variables of LPM at all times:

T_{f}:u(x,y,z,t)→w(t),∀(x,y,z)ϵΩ,∀t≥0.

An example of T_{f} of interest is given in FIG. 3, where T_{f} maps the unknown displacement of the top surface of absorber in the DPM to the absolute displacement of lumped spring-damper component in the LPM u(x, y, z, t)→w₄(t).

According to aspects of the present disclosure, the ‘Behavior of DPM’ B_{d} is the exact solution u=u(x, y, z, t) obtained by solving the DPM, e.g., the PDE (Eq.1) that satisfies the region of space-time and initial and boundary conditions. The ‘Behavior of LPM’ Bₗ is the exact solution w=w(t) obtained by solving the LPM, e.g., the ODEs (Eq.2) that satisfy the region of time and initial conditions.

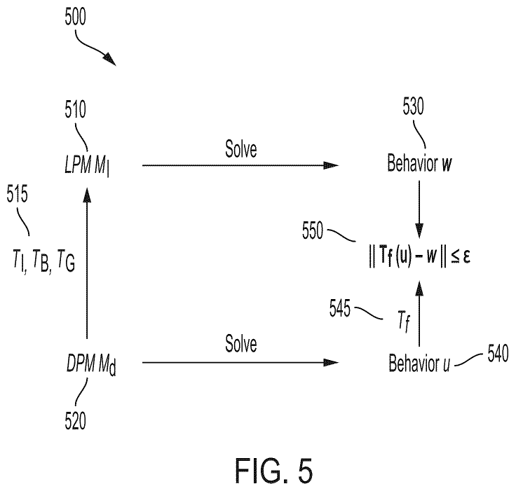

FIG. 5 illustrates an example 500 of matching the LPM 510 with a distributed-parameter model (DPM) 520, in accordance with certain aspects of the present disclosure. As shown, a LPM 510 and a DPM 520 are considered to be consistent if the norm of difference between the behavior 540 of DPM B_{d} after mapping T_{f} 545 and the behavior of LPM Bₗ 530 is less than a positive real number ϵ>0 at 550, providing input conditions 515 T_{I}, T_{B}, and T_{G}. The norm could be any type of vector norms. The commonly-used norms are L¹, L², and L^{∞}. Symbolically, ∥T_{f}(u)−w(t)∥≤ε.

FIG. 6 illustrates an example 600 of formulating a shape generation model or modeling for lumped parameter systems in a static mechanical domain, in accordance with certain aspects of the present disclosure. As shown, a lumped parameter model 530 is to be generated to map functions of the mechanical system 510. As an example according to aspects of the present disclosure, the shape generation modeling in FIG. 6 for lumped parameter systems is formulated below.

$${minimize}_{ρ} {J}_{k} {ρ}_{k} = \vert \frac{\int {ρ}_{k} {u}_{k} d {Ω}_{k}}{\int {ρ}_{k} d {Ω}_{k}} - {w}_{k} \vert ( Behavior corr . ) \\ subject to : \\ ( 1 ) \int {ρ}_{k} d {Ω}_{k} = {m}_{k} ( Mass corr . ) \\ ( 2 ) \frac{\int {r}_{k} {ρ}_{k} d {Ω}_{k}}{\int {ρ}_{k} d {Ω}_{k}} = {R}_{k} ( Gravity center corr . ) \\ ( 3 ) \int {r}_{k} {ρ}_{k} d \partial {Ω}_{k} = {F}_{k} . ( Neummann BC corr . ) \\ ( 4 ) \frac{\int {ρ}_{k} {u}_{k} d \partial {Ω}_{k}}{\int {ρ}_{k} d {Ω}_{k}} = {w}_{g} ( Dirichlet BC corr . ) \\ ( 5 ) K ( ρ ) u ( ρ ) = {\sum }_{k} {b}_{k} ( {ρ}_{k} ) + {\sum }_{k} {f}_{k} ( {ρ}_{k} ) ( FEA ) \\ ( 6 ) ρ = {\sum }_{k} {ρ}_{k} ( Superposition ) ,$$

where k=1, 2, . . . , n for the objective function and all constraints and n is the number of lumped masses in the system model.

The formulated model or modeling in FIG. 6 is an optimization model or modeling with the goal of finding a spatially-continuous density (ρ) distribution in a given design domain V, such that the difference of behavior of interest between LPM and DPM is minimized. The model or modeling subjects to six constraints as follows. Though not enumerated, other assembling and manufacturing constraints, in some cases, are also included.
(1) the mass value correspondence between lumped masses and mass of the shape, that is ∫ρₖdΩₖ mₖ. Herein, the designed shape is assumed to have multiple layers and the mass of the k-th layer corresponds to the lumped mass mₖ. The multiple layer structure may be superposed into one layer to get the final shape.
(2) the correspondence of gravity center between the k-th layer and the initial position of lumped mass mₖ. Symbolically, ∫rₖρₖdΩₖ/∫ρₖdΩₖ=Rₖ. Note that the combination of constraints (1) and (2) is essentially the body effect correspondence T_{G} introduced above in the section of definitions.
(3) the introduced Neumann boundary condition correspondence Tₙ.
(4) the introduced Dirichlet boundary condition correspondence T_{d}.
(5) the equilibrium constraint, where the design variable ρₖ and the displacement field are solved using a numerical equation generated from FEA.
(6) all the assumed layers may be superposed into a single layer:

$$( ρ = {\sum }_{k} {ρ}_{k} )$$

so that for each update of the design variable ρ in optimization, the numerical equation only needs to be solved once, instead of k times.

Aspects of the present disclosure may be discussed with linear-time invariant (LTI) static mechanical examples. The present disclosure includes two major steps for shape generation. First, the design space generation for topology optimization by using the specifications of the given system design (LPM), which includes specifying design domain and correspondences of boundary conditions, gravity field, and field of interest. Second, with the specified design space, using the topology optimization method to generate a part shape. Particularly, the classic SIMP method for topology optimization is adopted, but virtually every topology optimization method works, as long as they use the same type of design space.

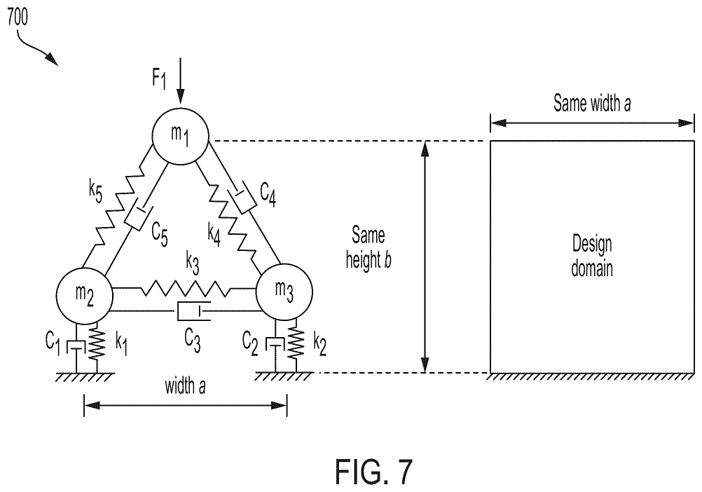

FIG. 7 illustrates an example 700 of generated design domains from initial positions of lumped components in an example of three-degrees-of-freedom, in accordance with certain aspects of the present disclosure. A design domain of reasonable size and shape is specified with appropriate boundary conditions. For example, the specifications of a LPM are taken into consideration to generate a reasonable design space. The present disclosure provides automatic design space generation and supports modifications based on user input.

As shown in FIG. 7, the present disclosure may use a bounding box that can cover all the initial positions of lumped components (including ground) as a default design domain. The initial positions must be measured at the equilibrium state where velocities and deformations of components are zero. Users can change the size and shape of the design domain with respect to any special design requirements. For example, FIG. 6 shows an example of design domain generation, where the LPM is a three degree-of-freedom (d.o.f) mass-spring-damper model. The distance between the ground and the initial position of the mass m₁ is used as the height of the design domain and the distance between the initial positions of masses m₂ and m₃ is used as the width of the design domain. It can be observed that, such a design domain is a bounding box covering all the initial positions of lumped components.

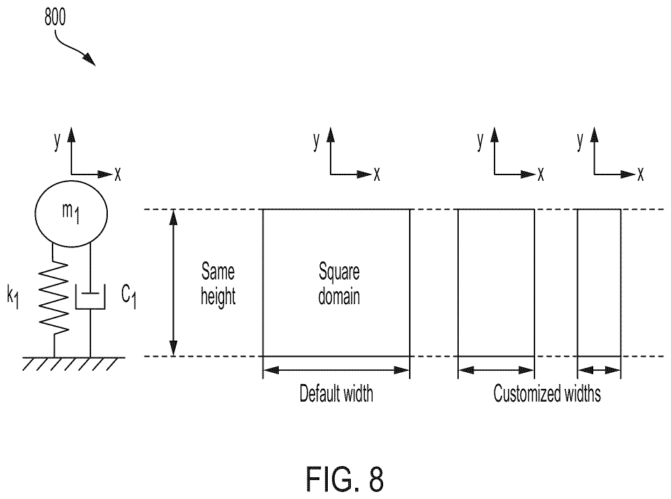

FIG. 8 illustrates an example 800 of generated design domains from initial positions of lumped components, in accordance with certain aspects of the present disclosure. As shown, there are a class of mechanical models that may need only one-dimensional length l for the bounding box. These models include but not limited to a single d.o.f mass-spring-damper model as shown in FIG. 8 and a serial vertically/horizontally connected mass-spring-damper components. For such cases, the present disclosure propose to use a bounding box that is a square for 2D design or a cube for 3D design as the default design domain. Moreover, the bounding box is symmetric with respect to the axis at which the one-dimensional length l measured.

FIG. 8 shows such an example, where a single d.o.f mass-spring-damper model is given where only one-dimensional height along y axis is known for building the bounding box. The generated default design domain is a square box for 2D design, which is symmetric to the y-axis. Two other customized design domains with different widths are given in the figure, which may allow using stiffer but less material to realize the same equivalent stiffness k₁ in the system.

After the design domain is specified, appropriate boundary conditions are added to the design domain prepared for the later shape design with topology optimization methods. When adding the boundary conditions, four factors are considered: (1) location at the boundary, (2) shape and occupied boundary area, (3) physical variable type, and (4) numerical values. In the present disclosure, a default boundary condition correspondence may be provided for automation.

Specifically, the lumped sources, including forces and mass displacements (including the fixed ground), may be respectively mapped to concentrated forces (as Neumann boundary condition) and displacement (as Dileclet boundary condition) added to the boundary, with the same locations and values as they are in the LPM. In other words, lumped forces and mass displacements may be directly embedded on the generated design domain and used as new boundary conditions for topology optimization. Particularly, for one-dimensional LPMs (e.g. single d.o.f models as shown in FIG. 8), the fixed ground (a point) may be mapped to a fixed surface with a user-defined shape and occupied area located at the same position to avoid unstable FEA analysis in topology optimization. Users can change the default boundary condition correspondence to others, as long as it satisfies the boundary conditions defined.

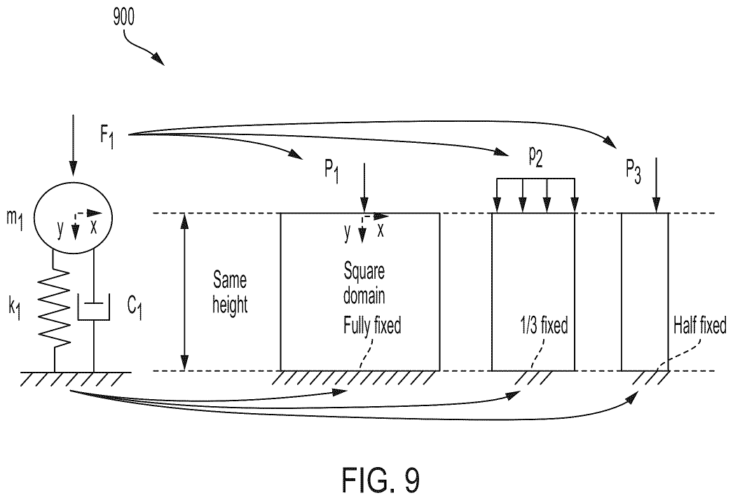

FIG. 9 illustrates an example 900 of generating boundary conditions from lumped sources, in accordance with certain aspects of the present disclosure. As shown, the single d.o.f mass-spring-damper model is used as the LPM and the specified design domains are from FIG. 8. The present disclosure uses three different example boundary condition mappings for both lumped force F₁ and the fixed ground. Specifically, F₁→P₁ is the default mapping, where F₁ is mapped to a concentrated force P₁ at the same location (the initial position of m₁). The uniformly-distributed pressure p₁=F₁/a (a is the width of the domain) and concentrated force P₃ located at ⅔ of the width are two customized Neumann boundary conditions. As for the fixed ground of LPM, three customized mappings are used, which map it to the fully fixed, ⅓ fixed, and half fixed ground of three design domains, respectively. All the customized force and fixed ground mappings could be determined by considering how the designed part may be used in practice.

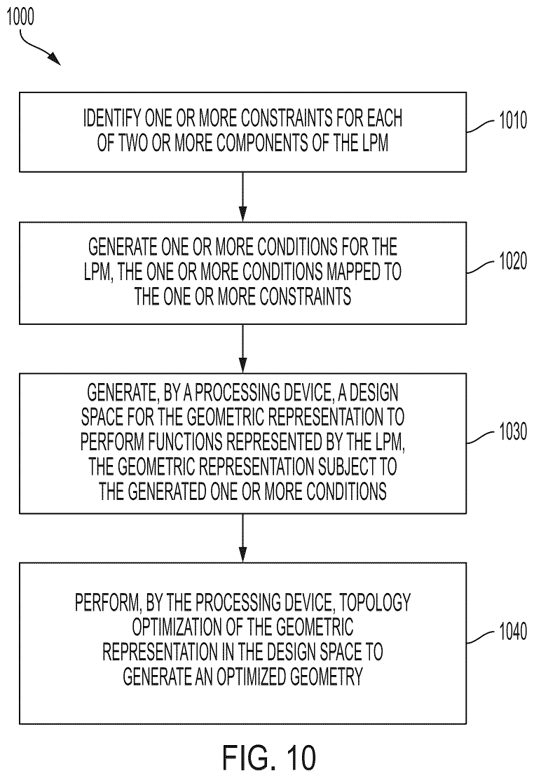

FIG. 10 illustrates a flow diagram of methods of operations 1000, in accordance with certain aspects of the present disclosure. For example, the operations 1000 may correspond to the processes described with reference to FIG. 11. The operations 1000 may be performed by a processing device, such as the LPM model based geometric representation TO processing device 160 as described with reference to FIG. 1.

The operations 1000 begins at 1010, by identifying one or more constraints for each of two or more components of the LPM. A geometric representation will be generated directly based on the LPM.

At 1020, one or more conditions are generated for the LPM. The one or more conditions are mapped to the one or more constraints.

At 1030, a processing device generates a design space for the geometric representation to perform functions represented by the LPM. The geometric representation is subject to the generated one or more conditions.

At 1040, the processing device performs topology optimization of the geometric representation in the design space to generate an optimized geometry. For example, the optimized geometry is a converged shape that performs the desired functions of the LPM.

According to aspects of the present disclosure, the processing device may generate the design space by receiving a network of connected lumped components for the LPM; and identifying one or more corresponding lumped sources acting on the network of connected lumped components of the LPM. In some cases, a geometric design domain that bounds a shape and a size of the geometric representation is determined based on an initial position of each of the two or more components of the LPM. The one or more corresponding lumped sources may include the initial position of each of the two or more components.

In some cases, the one or more corresponding lumped sources correspond to at least a portion of the one or more constraints. The one or more constraints may include initial conditions and boundary conditions of the two or more components. The initial conditions and boundary conditions may specify functional requirements for the two or more components. In some cases, performing the topology optimization of the geometric representation includes obtaining material properties and manufacturing parameters associated with an additive manufacturing process of the geometric representation (or the TO output). An optimized material layout may be generated to satisfy: the one or more corresponding lumped sources, the material properties of the geometric representation; and the manufacturing parameters associated with the additive manufacturing process.

According to aspects of the present disclosure, performing the topology optimization of the geometric representation may include performing at least one of: solid isotropic material with penalization (SIMP) method; an element-based topology optimization method; a rational approximation of material properties method; an optimal microstructure with penalization method; an evolutionary structural optimization method; an additive evolutionary structural optimization method; a level-set topology optimization method; or a bidirectional evolutionary structural optimization method.

According to aspects of the present disclosure, the geometric representation may include a shape to perform functions of the LPM. The shape is specific to one or more materials to be used and specific to manufacturing techniques specific to the one or more materials to be used. For example, strength, longevity, weight, and other performance aspects of the geometric representation may be considered and included into the topology optimization process.

Various operations are described as multiple discrete operations, in turn, in a manner that is most helpful in understanding the present disclosure, however, the order of description may not be construed to imply that these operations are necessarily order dependent. In particular, these operations need not be performed in the order of presentation.

FIG. 11 illustrates a flow diagram of shape generation approach for lumped parameter systems according to a topology optimization method of the present disclosure. As shown, the present disclosure provides a topology optimization method different from classical topology optimization methods in the following aspects. In classical topology optimization methods, the objective function is a physics-based performance metric (e.g., stiffness or strength) evaluated by a forward solver (e.g. FEA), but the present disclosure uses measures of consistency between part-level and system-level behavior as the objective function.

In FIG. 11, a lumped-parameter model is provided (e.g., from 1030 of FIG. 10). The processing device may, based on existing settings or user input, elect whether default mapping should be applied. If not, customized mapping may be applied. Either default mapping or the customized mapping would further be used to define or generate a design domain and one or more boundary conditions, which are provided to forming an optimization model or modeling or model to be solved. The optimization model or modeling or model may be represented in an FEA model and a network of nodes, with behavior comparison included to specify various conditions, constraints, or assumptions.

Once the optimization model has been generated, sensitivity analysis is performed, similar to classical topology optimization procedures. Filters are then applied. Density distribution that represents the shape of the geometric representation is updated during the optimization procedure. If the results converge, an optimal result has been reached and the final topology is output.

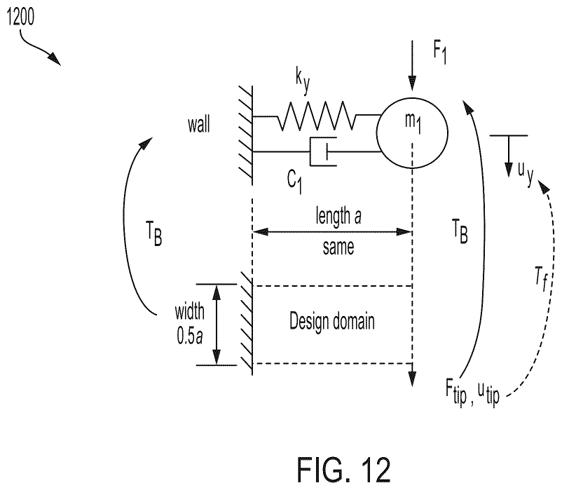

FIG. 12 illustrates an example of a one degree-of-freedom mass-spring-damper model 1200 and its design space, for demonstrating aspects of the present disclosure. The present disclosure uses examples to illustrate the framework and results with lumped mass-spring-damper models that have different degree(s) of freedoms (d.o.f). Such models are usually used for mechanical designs at the functional level, where masses, springs, and dampers have different functions. Specifically, masses and springs both have the function of energy storage even though the form of the stored energy is different, with the energy stored in masses being the kinetic energy whereas the energy stored in springs being the elastic potential energy. Dampers dissipates energies to control the spring oscillation.

In the examples, the present disclosure aims to generate one geometric part for each provided lumped mass-spring-damper model, such that they satisfy the model consistency conditions introduced above. Specifically, the given models are LTI models, where the lumped parameters are constant. Initial displacement and velocity of all the components are zero. Gravity of masses are ignored. In particular, the first example is a simple single d.o.f mass-spring-damper model. The present disclosure may this example to explain the general idea behind the framework because its shape generation could be a typical cantilever beam obtained by topology optimization. After that, the framework is used for several three d.o.f mass-spring-damper models that have the same topology but different lumped parameters and initial positions of components. In principle, the present disclosure works for arbitrary d.o.f of mass-spring-damper model. More general embodiments can be obtained by straightforward extension to different domains of physics (or coupled multi-physics), and linear and nonlinear constitutive laws.

As shown in FIG. 12, the present disclosure may show the results of the proposed framework applied to the lumped mass-spring-damper model 1200 whose spring and mass are placed horizontally. The lumped mass m₁=900 g, spring stiffness at vertical direction k_{y}=556 N/m, and lumped force F₁=1N. Gravity of the mass is ignored. The behavior of interest is the vertical displacement u_{y} of the mass at the steady state. The value of mass m₁ may not affect the steady state, meaning that the steady displacement is only related to k_{y} and F₁. This example is to generate a family of different qualified 2D shape for the single d.o.f mass-spring-damper model. These shapes differ from the target mass value M but the case M=m₁=900 g is included.

By using the initial position of the mass m₁, a design domain is built as shown in FIG. 12, whose length a is a default value which is the same as the distance between the mass and the wall while a customized width b−0.5a is given to the domain. The boundary conditions are then added to the design domain. Considering how the designed part would be used in practice, customized boundary condition and field of interest correspondences are used. Specifically, a concentrated force Fₜᵢₚ corresponding to lumped force F₁ (via Tₙ) is added to the right lower end of the domain, which has the same direction and value as F₁. In addition, the displacement of left side of the design domain is zero, corresponding to zero displacement of the end of the spring and damper (via T_{d}). The behavior of interest uₜᵢₚ is the displacement of the right lower end of the domain at the steady state, corresponding to displacement u_{y} of the mass m₁ at the steady state (via T_{f}). A qualified designed part must be one whose uₜᵢₚ is close to u_{y}.

FIGS. 13A-13F illustrate example topology optimization results of shapes generated for the mass-spring-damper model of FIG. 12, for demonstrating aspects of the present disclosure. With the generated design domain, boundary conditions, and the appointed behavior of interest shown in FIG. 12, topology optimization is performed to generate a qualified 2D shape. Six examples of the optimization results are shown in FIGS. 13A-13F.

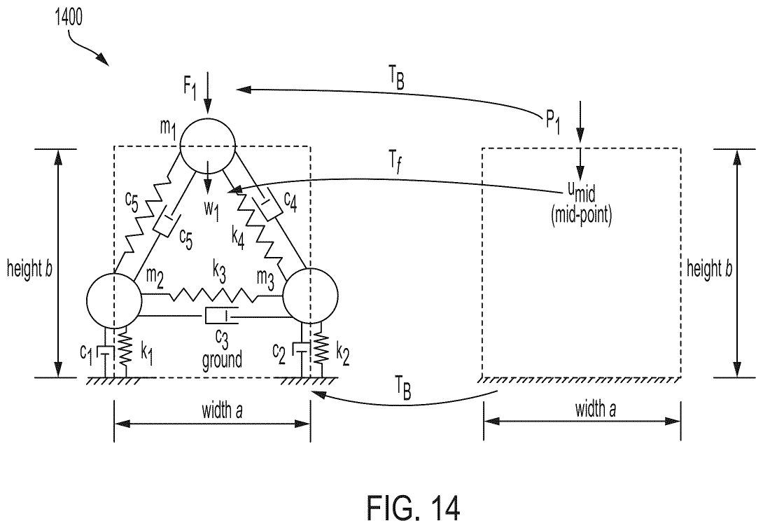

Specifically, the design domain is spatially discretized by 60 by 30 finite quadrilateral elements. The Young's Modulus and the Poisson's ratio of the selected material are E−1 Gpa and v=0.3, respectively. The MMA optimizer with default parameters is used for density distribution update. The present disclosure generate the part design with six different target mass values, from M=540 g to M=1440 g increased by interval 180 g. In FIG. 14, the respective computed errors are 101.19%, 13.06%, 0.11%, 0.16%, 0.43%, and 0.54%.

When the target mass value is small, for example, M=540 g or M=720 g, the error is observed to be greater than 10% in the example, attributable to the amount of material that could be used in the design domain being so little that no matter how the present disclosure distribute it in the design domain, a qualified shape may not be generated by the optimization. However, if the target mass value M increases above 900 g, the present disclosure start getting good results. Nevertheless, if the mass value is too large, for example, the material is everywhere in the design domain M=1800 g, then the design error becomes bad again (tested but not shown in the figure). The reason for it is there is too much material but few space to re-distribute it to meet the model consistency requirement.

Generally, with a fixed design domain, the optimal target mass values M would be different with respect to different selected material properties, but it always follows the pattern that too little material may give bad part design result, but as the M increases, the result improves, and might goes down when M is too large.

FIG. 14 illustrates an example of a multi d.o.f. mass-spring-damper system-level model and a design space generated for topology optimization, for demonstrating aspects of the present disclosure. As shown, the three d.o.f. system-level model includes three masses (gravitational effects ignored) connected together through a network of springs and dampers. Two springs and two dampers are fixed to the ground. A lumped force F₁ acts on the mass m₁. The output of interest is the vertical steady-state displacement w₁ of mass m₁. One goal of this example is to generate a qualified 2D shape for 10 different cases listed in the Table 1, where the dimensions are masses mₖ−g, Young's Modulus E−Gpa, displacement of designed part Disp−1×10⁻⁸ mm, and displacement w₁−1×10⁻⁸ mm of lumped mass m₁. These cases differ in the lumped masses values (m₁, m₂, m₃), gravity centers of three masses, spring and damper values (hence displacement w₁, and types of Neumann boundary condition mapped from lumped force to the design domain which are concentrated (conc.) or distributed (distr.).

TABLE 1
Parameter values for the topology optimization algorithm

| | | | | | Gravity | | | | | | | | |
|---|---|---|---|---|---|---|---|---|---|---|---|---|---|
| Name | BC type | m₁ | m₂ | m₃ | Centers | E | Iter | VF1 | VF2 | VF3 | Disp | w₁ | Error |
| Case 1 | “conc.” | 900 | 540 | 540 | (15, 50), | 100 | 200 | 0.5 | 0.1 | 0.3 | 39.625 | 40 | 0.94% |
| | | | | | (5, 10), | | | | | | | | |
| | | | | | (25, 10) | | | | | | | | |
| Case 2 | “conc.” | 540 | 540 | 540 | (15, 50), | 100 | 200 | 0.3 | 0.1 | 0.3 | 39.655 | 40 | 0.86% |
| | | | | | (5, 10), | | | | | | | | |
| | | | | | (25, 10) | | | | | | | | |
| Case 3 | “conc.” | 180 | 360 | 360 | ((15, 50), | 500 | 200 | 0.1 | 0.1 | 0.3 | 7.978 | 8 | 0.28% |
| | | | | | (5, 10), | | | | | | | | |
| | | | | | (25, 10) | | | | | | | | |
| Case 4 | “conc.” | 720 | 900 | 540 | (15, 50), | 500 | 200 | 0.4 | 0.1 | 0.5 | 7.922 | 8 | 0.98% |
| | | | | | (5, 10), | | | | | | | | |
| | | | | | (25, 10) | | | | | | | | |
| Case 5 | “conc.” | 900 | 540 | 540 | (5, 50), | 100 | 200 | 0.5 | 0.1 | 0.3 | 39.619 | 40 | 0.95% |
| | | | | | (10, 5), | | | | | | | | |
| | | | | | (27.5, 10) | | | | | | | | |
| Case 6 | “conc.” | 900 | 540 | 540 | (15, 50), | 100 | 200 | 0.5 | 0.095 | 0.3 | 165.588 | 165 | 0.36% |
| | | | | | (5, 10), | | | | | | | | |
| | | | | | (25, 10) | | | | | | | | |
| Case 7 | “distr.” | 900 | 540 | 540 | (15, 50), | 100 | 500 | 0.5 | 0.1 | 0.3 | 11.068 | 11 | 0.62% |
| | | | | | (5, 10), | | | | | | | | |
| | | | | | (25, 10) | | | | | | | | |
| Case 8 | “distr.” | 540 | 540 | 540 | (15, 50), | 100 | 400 | 0.3 | 0.1 | 0.3 | 11.083 | 11 | 0.75% |
| | | | | | (5, 10), | | | | | | | | |
| | | | | | (25, 10) | | | | | | | | |
| Case 9 | “distr.” | 720 | 900 | 540 | (15, 50), | 500 | 300 | 0.4 | 0.069 | 0.5 | 1.659 | 1.65 | 0.55% |
| | | | | | (5, 10), | | | | | | | | |
| | | | | | (25, 10) | | | | | | | | |
| Case 10 | “distr.” | 900 | 540 | 540 | (5, 50), | 100 | 400 | 0.5 | 0.1 | 0.3 | 11.049 | 11 | 0.45% |
| | | | | | (10, 5), | | | | | | | | |
| | | | | | (27.5, 10) | | | | | | | | |

By using initial position of three lumped masses, a design domain may be generated. As shown in FIG. 14, the design domain includes a width a, which is the distance between m₂ and m₃ and the height b, which is the distance between m₁ and ground.

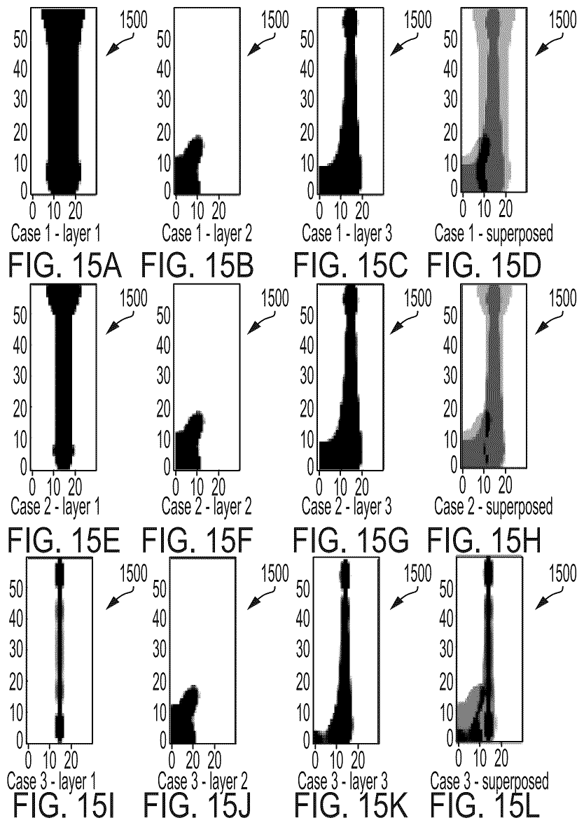

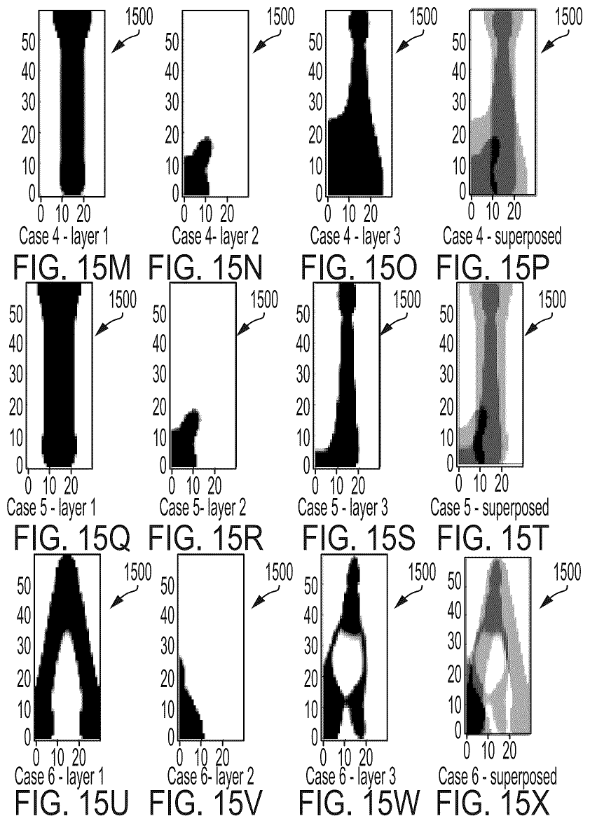

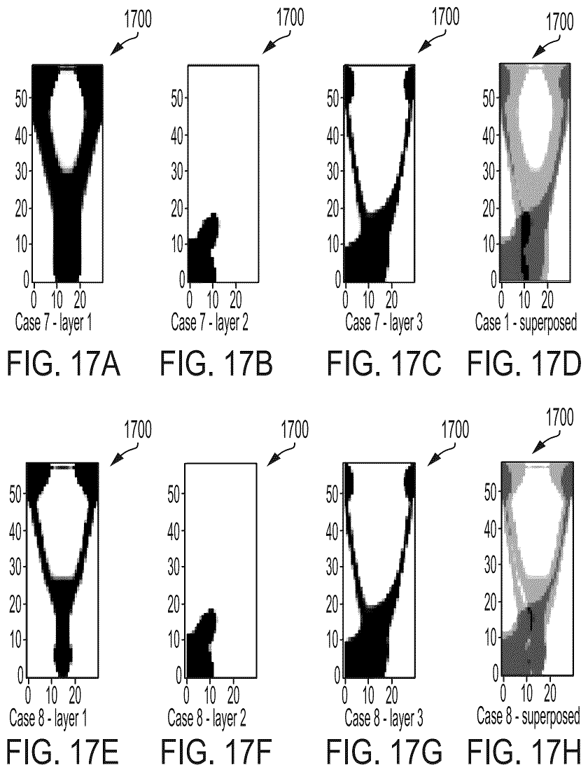

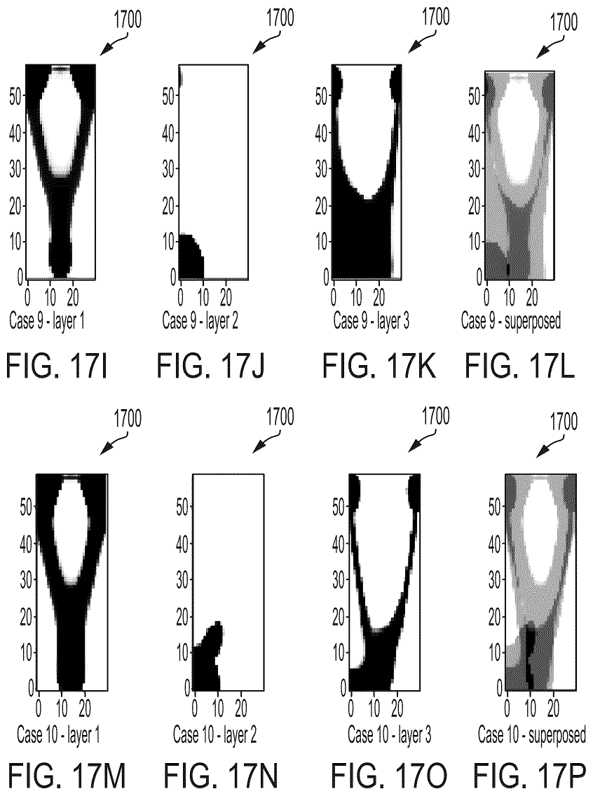

As mentioned above, in this example, lumped force F₁ is mapped to either a concentrated force (cases 1˜6), as shown in FIGS. 15A-15X; or a distributed pressure (cases 7˜10), as shown in FIGS. 17A-17P.

The bottom of design domain is fixed to the ground which corresponds to the fixed end of the springs k₁, k₂ and damper c₁, c₂. In cases 1˜6, the behavior of interest u_{mid} is steady-state displacement of the mid-point on top surface. In cases 7˜10, the behavior of interest ū is the average steady-state displacement of top surface. Both u_{mid} and ū corresponds to steady-state displacement w₁ of mass m₁. A qualified designed part must be the one whose u_{mid} (cases 1˜6) and ū (cases 7˜10) is close to u_{y}.

Once the design space is generated, the SIMP method used to generate an optimized shape automatically. For example, the continuous design domain may be discretized with 30 quadrilateral elements along x-axis and 60 quadrilateral elements along y-axis. The Poisson's ratio of the selected material is v=0.3. Young's Modulus used for each case is given in the Table 1. The method of moving asymptotes (MMA) optimizer with default parameters is used for density distribution update.

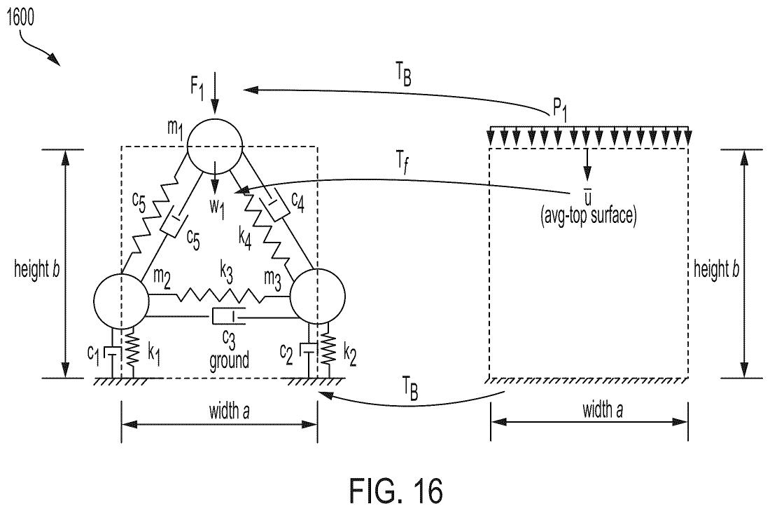

FIG. 16 illustrates an example of a multi d.o.f. mass-spring-damper system-level model and a design space generated for topology optimization, for demonstrating aspects of the present disclosure. The multi d.o.f. model in FIG. 16 is similar to that in FIG. 14 except that the loading condition is of a distributed load instead of a concentrated load.

The SIMP method is applied to generate an optimized geometric representation for the system-level model of FIG. 16. In an embodiment, to simplify the implementation process, the design domain of the same shape and size is used for each layer, and the boundary condition values are equally distributed to design domains at each layer. The three layers may be independently designed and the combined value of objectives at three layers is used to drive the optimizer. Using SIMP to 10 cases in Table 1, with the objective function and six constraints. The results related to each case-study have been presented in FIGS. 17A-17P.

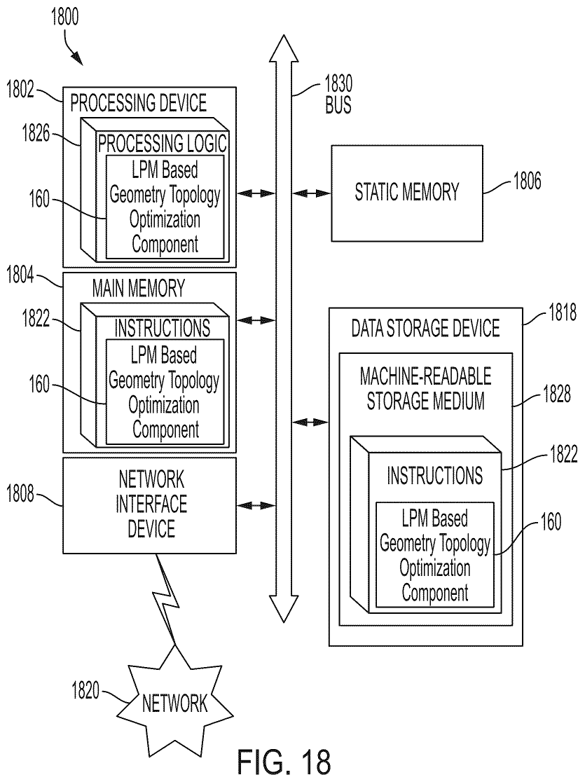

FIG. 18 illustrates a diagrammatic representation of a machine in the example form of a computer system 1800 within which a set of instructions 1822, for causing the machine to perform any one or more of the methodologies discussed herein (such as the operations 1000), may be executed. In various embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 1800 may be representative of a server computer system, such as system 100.

The exemplary computer system 1800 includes a processing device 1802, a main memory 1804 (e.g., read-only memory (ROM), flash memory, dynamic random access memory (DRAM), a static memory 1806 (e.g., flash memory, static random access memory (SRAM), etc.), and a data storage device 1818, which communicate with each other via a bus 1830. The processing device 1802 may be implemented as the LPM model based geometric representation TO processing device 160 (component), or a related processing device unit. In some cases, the processing device 1802 may be used to perform tasks associated with the LPM model based geometric representation TO processing device 160 (or component 160). Any of the signals provided over various buses described herein may be time multiplexed with other signals and provided over one or more common buses. Additionally, the inter1829 connection between circuit components or blocks may be shown as buses or as single signal lines. Each of the buses may alternatively be one or more single signal lines and each of the single signal lines may alternatively be buses.

Processing device 1802 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1802 may also be one or more special-purpose processing devices such as an application specific integrated circuit (ASIC), a field programmable gate array (FPGA), a digital signal processor (DSP), network processor, or the like. The processing device 1802 may execute processing logic 1826, which may be one example of system 100 shown in FIG. 1, for performing the operations and steps discussed herein, such as the operation 1000 of FIG. 10. The processing logic 1826 may include the computational module 132 for determining domains and conditions mapping of FIG. 1.

The data storage device 1818 may include a machine-readable storage medium 1828, on which is stored one or more set of instructions 1822 (e.g., software) embodying any one or more of the methodologies of functions described herein, including instructions to cause the processing device 1802 to execute system 100. For example, the instructions 1822 may include the computational module 132 for determining domains and conditions mapping. The instructions 1822 may also reside, completely or at least partially, within the main memory 1804 or within the processing device 1802 during execution thereof by the computer system 1800; the main memory 1804 and the processing device 1802 also constituting machine-readable storage media. The instructions 1822 may further be transmitted or received over a network 1820 via the network interface device 1808.

The non-transitory machine-readable storage medium 1828 may also be used to store instructions to perform the methods and operations described herein. While the machine-readable storage medium 1828 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass embodiments in hardware, software, or a combination thereof.

What is claimed is:

1. A method for generating a geometric representation based on a lumped parameter model (LPM), the method comprising:
identifying one or more constraints for each of two or more components of the LPM;
generating one or more conditions for the LPM, the one or more conditions mapped to the one or more constraints;
generating, by a processing device, a design space for the geometric representation to perform functions represented by the LPM, the geometric representation subject to the generated one or more conditions; and
performing, by the processing device, topology optimization of the geometric representation in the design space to generate an optimized geometry.

2. The method of claim 1, wherein generating the design space for the geometric representation of the LPM comprises:
receiving a network of connected lumped components for the LPM; and
identifying one or more corresponding lumped sources acting on the network of connected lumped components of the LPM.

3. The method of claim 2, wherein generating the design space for the geometric representation of the LPM comprises:
determining a geometric design domain that bounds a shape and a size of the geometric representation, based on an initial position of each of the two or more components of the LPM, and wherein the one or more corresponding lumped sources include the initial position of each of the two or more components.

4. The method of claim 2, wherein the one or more corresponding lumped sources correspond to at least a portion of the one or more constraints, wherein the one or more constraints comprise initial conditions and boundary conditions of the two or more components, the initial conditions and boundary conditions specifying functional requirements for the two or more components.

5. The method of claim 4, wherein performing the topology optimization of the geometric representation comprises:
obtaining material properties and manufacturing parameters associated with an additive manufacturing process of the geometric representation; and
generating an optimized material layout to satisfy:
the one or more corresponding lumped sources,
the material properties of the geometric representation; and
the manufacturing parameters associated with the additive manufacturing process.

6. The method of claim 1, wherein performing the topology optimization of the geometric representation comprises performing at least one of:
solid isotropic material with penalization (SIMP) method;
an element-based topology optimization method;
a rational approximation of material properties method;
an optimal microstructure with penalization method;
an evolutionary structural optimization method;
an additive evolutionary structural optimization method;
a level-set topology optimization method; or
a bidirectional evolutionary structural optimization method.

7. The method of claim 1, wherein the geometric representation comprises:
a shape to perform functions of the LPM, wherein the shape is specific to one or more materials to be used and specific to manufacturing techniques specific to the one or more materials to be used.

8. An apparatus for generating a geometric representation based on a system level representation, the apparatus comprising:
a memory;
a processing device unit operatively coupled to the memory, the processing device unit to:
identify one or more constraints for each of two or more components of the LPM;
generate one or more conditions for the LPM, the one or more conditions mapped to the one or more constraints;
generate, by a processing device, a design space for the geometric representation to perform functions represented by the LPM, the geometric representation subject to the generated one or more conditions; and
perform, by the processing device, topology optimization of the geometric representation in the design space to generate an optimized geometry.

9. The apparatus of claim 8, wherein the processing device unit is to generate the design space for the geometric representation of the system level representation by:
receiving a network of connected lumped components for the system level representation, the system level representation comprising a lumped parameter model (LPM); and
identifying one or more corresponding lumped sources acting on the network of connected lumped components of the system level representation.

10. The apparatus of claim 9, wherein the processing device unit is to generate the design space for the geometric representation of the system level representation by:
determining a geometric design domain that bounds a shape and a size of the geometric representation, based on an initial position of each of the two or more components of the system level representation, and wherein the one or more corresponding lumped sources include the initial position of each of the two or more components.

11. The apparatus of claim 9, wherein the one or more corresponding lumped sources correspond to at least a portion of the one or more constraints, wherein the one or more constraints comprise initial conditions and boundary conditions of the two or more components, the initial conditions and boundary conditions specifying functional requirements for the two or more components.

12. The apparatus of claim 11, wherein the processing device unit is to perform the topology optimization of the geometric representation by:
obtaining material properties and manufacturing parameters associated with an additive manufacturing process of the geometric representation; and
generating an optimized material layout to satisfy:
the one or more corresponding lumped sources,
the material properties of the geometric representation; and
the manufacturing parameters associated with the additive manufacturing process.

13. The apparatus of claim 8, wherein the processing device unit is to perform the topology optimization of the geometric representation by performing at least one of:
solid isotropic material with penalization (SIMP) method;
an element-based topology optimization method;
a rational approximation of material properties method;
an optimal microstructure with penalization method;
an evolutionary structural optimization method;
an additive evolutionary structural optimization method;
a level-set topology optimization method; or
a bidirectional evolutionary structural optimization method.

14. The apparatus of claim 8, wherein the geometric representation comprises:
a shape to perform functions of the system level representation, wherein the shape is specific to one or more materials to be used and specific to manufacturing techniques specific to the one or more materials to be used.

15. A non-transitory computer-readable storage medium having instructions stored thereon that, when executed by a processing device for generating a geometric representation based on a lumped parameter model (LPM), cause the processing device to:
identify one or more constraints for each of two or more components of the LPM;
generate one or more conditions for the LPM, the one or more conditions mapped to the one or more constraints;
generate, by a processing device, a design space for the geometric representation to perform functions represented by the LPM, the geometric representation subject to the generated one or more conditions; and
perform, by the processing device, topology optimization of the geometric representation in the design space to generate an optimized geometry.

16. The non-transitory computer-readable storage medium of claim 15, further comprising instructions to cause the processing device to generate the design space for the geometric representation of the LPM by:
receiving a network of connected lumped components for the LPM; and
identifying one or more corresponding lumped sources acting on the network of connected lumped components of the LPM.

17. The non-transitory computer-readable storage medium of claim 16, further comprising instructions to cause the processing device to generate the design space for the geometric representation of the LPM by:
determining a geometric design domain that bounds a shape and a size of the geometric representation, based on an initial position of each of the two or more components of the LPM, and wherein the one or more corresponding lumped sources include the initial position of each of the two or more components.

18. The non-transitory computer-readable storage medium of claim 16, wherein the one or more corresponding lumped sources correspond to at least a portion of the one or more constraints, wherein the one or more constraints comprise initial conditions and boundary conditions of the two or more components, the initial conditions and boundary conditions specifying functional requirements for the two or more components.

19. The non-transitory computer-readable storage medium of claim 18, further comprising instructions to cause the processing device to perform the topology optimization of the geometric representation by:
obtaining material properties and manufacturing parameters associated with an additive manufacturing process of the geometric representation; and
generating an optimized material layout to satisfy:
the one or more corresponding lumped sources,
the material properties of the geometric representation; and
the manufacturing parameters associated with the additive manufacturing process.

20. The non-transitory computer-readable storage medium of claim 15, wherein the geometric representation comprises:
a shape to perform functions of the LPM, wherein the shape is specific to one or more materials to be used and specific to manufacturing techniques specific to the one or more materials to be used.
